(19) United States
(12) Patent Application Publication
(10) Pub. No.: US 2026/0216992 A1
(43) Pub. Date: Jul. 30, 2026

(54) LIGHTWEIGHT, FLAME RESISTANT FABRICS PROTECTIVE AGAINST ARC FLASH AND THERMAL PERFORMANCE

(71) Applicant: National Safety Apparel, LLC., Cleveland, OH (US)

(72) Inventors: Robert W. Hines, JR., Spartanburg, SC (US); James Jonathan Bailey, Fortson, GA (US); Lucija Kobal, AJDOVSCINA (SI)

(21) Appl. No.: 19/037,630

(22) Filed: Jan. 27, 2025

(51) Int. Cl. B32B 5/26; B32B 5/02; B32B 7/022; D03D 15/225; D03D 15/283; D03D 15/513; D03D 15/533; D04H 1/4342

(52) U.S. Cl. CPC B32B 5/267; B32B 5/022; B32B 5/024; B32B 5/277; B32B 7/022; D03D 15/225; D03D 15/283; D03D 15/513; D03D 15/533; D04H 1/4342; B32B 2250/04; B32B 2250/20; B32B 2250/40; B32B 2262/0261; B32B 2262/0269; B32B 2262/04; B32B 2262/144; B32B 2307/21; B32B 2307/3065; B32B 2307/558; B32B 2571/00; D10B 2331/021; D10B 2501/04

(57) ABSTRACT

A fabric assembly includes a front layer made of a first woven fabric, a back layer made of a second woven fabric, a first interlayer made of a first non-woven fabric, and a second interlayer made of a second non-woven fabric. The first and second interlayers are disposed between the front layer and the back layer, the first interlayer directly contacts the front layer and the second interlayer directly contacts the back layer. The fabric assembly is perfluoroalkyl and polyfluoroalkyl substances (PFAS)-free and has an arc thermal performance value (ATPV) of greater than 39 calories/centimeter square (cal/cm²) when a net weight of the fabric assembly is between about 260 gram/square meter (g/m²) and about 370 g/m².

### TECHNICAL FIELD

The present disclosure generally relates to performance fabrics. More particularly, the disclosure relates to lightweight, heigh energy arc flash resistant fabrics and articles made from the fabrics.

### BACKGROUND

Light weight arc flash protective systems are needed to protect electrical workers who work in hot environments where the potential for high-energy arc flash hazards exists. Previously, perfluoroalkyl and polyfluoroalkyl substances (PFAS) are used in protective clothing to improve performance and safety, but PFAS can have negative impacts on the environment. Extensive legislation has highlighted the environmental concerns around the manufacturing and use of PFAS-containing products. Although PFAS-free systems are available, they are less protective compared to products that contain PFAS.

### SUMMARY

A fabric assembly includes a front layer made of a first woven fabric, a back layer made of a second woven fabric, a first interlayer made of a first non-woven fabric, and a second interlayer made of a second non-woven fabric. The first and second interlayers are disposed between the front layer and the back layer, the first interlayer directly contacts the front layer and the second interlayer directly contacts the back layer. The fabric assembly is perfluoroalkyl and polyfluoroalkyl substances (PFAS)-free and has an arc thermal performance value (ATPV) of greater than 39 calories/centimeter square (cal/cm²) when a net weight of the fabric assembly is between about 260 gram/square meter (g/m²) and about 370 g/m².

An article includes or made of the fabric assembly disclosed herein. A method of making or assembling the fabric assembly and/or the article disclosed herein.

### DESCRIPTION OF THE DRAWINGS

FIG. 1 shows an exemplary fabric assembly for a lightweight, PFAS-free, wash-durable and highly protective fabric system.

FIG. 2 shows an exemplary patten and quilting dimensions for the fabric assembly of FIG. 1.

### DETAILED DESCRIPTION

The present disclosure is directed to flame-resistant fabric assembly for protection against burn injury (thermal heat transfer) from a high energy electrical arc flash. Fabric assembly may be fashioned into an arc flash clothing or article which may include but is not limited to apparel, hood, coat, or coverall. Electrical workers are required to wear arc rated flame resistant clothing in order to be sufficiently protected from life threatening burns should an arc flash incident occur.

Previously, perfluoroalkyl and polyfluoroalkyl substances (PFAS) are used in protective clothing to improve performance and safety, but PFAS can have negative impacts on environment. Although lightweight PFAS-free products are available on the market, they are less protective than products that contain PFAS. For example, a lightweight arc flash protective system from Salisbury by Honeywell International Inc. is PFAS-free but is only rated with 40 calories/centimeter square (cal/cm²) arc flash protection. Furthermore the 40 cal/cm² rating is an energy break-open threshold (EBT) arc flash rating, meaning that there is a 50% probability of material break open at that energy level.

The present disclosure is directed to lightweight products that are PFAS-free and able to provide a high energy arc resistance including a high level of break open resistance.

The present disclosure provides a PFAS-free, highly protective lightweight fabric system. Conventional systems incorporate PFAS as an essential part of the protective structure or are subject to break open at lower arc flash energies. Surprisingly, the lightweight products disclosed herein are able to achieve an unexpectedly high arc thermal performance value (ATPV) rating (meaning heat transferred through the fabric rather than breaking open) of 46 cal/cm² with a calculated breakopen energy of 55.59 cal/cm² at a relatively low weight of 360 gram/meter square (g/m²). Breakopen is an important factor in arc ratings because when a breakopen occurs, non-flame-resistant layers may ignite when exposed to high energy arc flash levels.

### Arc Flash Definition

An arc flash occurs in an electrical installation whenever there is an insulation failure or short circuit. The short creates an undesired electric discharge that travels through the air between conductors or from a conductor to ground. The arc flash generates a brilliant flash of light and ionized conductive plasma with temperatures in excess of 9000° F. The thermal energy can set fire to clothing and severely burn human skin even at a significant distance from the event. In fact, fatal burns can occur at distances of over 10 ft. According to Hoagland, Arc flashes are powerful explosions that can have a heat flux exceeding 50-100 cal/cm²/s. Not only is there a thermal hazard when exposed to an arc flash, but protection is also required from the potential additional hazards of molten metal and plasma. Further, Ralph Lee's in “Pressures Developed by Arcs,” cites several case histories illustrating the powerful pressure created by arc flash. In one example, an electrician working on a 480 V system is knocked 25 feet when an approximate 100 kA bolted fault occurred. Using Lee's formula, the approximate initial impulse force at 24 inches is calculated at about 260 lb/ft² based on Equation (1).

$$Pounds / {ft}^{2} = ( 11.5 \times kA arc ) \div {( distance from arc in feet )}^{0.9} \qquad Equation ( 1 )$$

An arc flash is a powerful explosion of force and thermal energy. In the picture a mannequin is placed in front of an electrical panel and an arc flash is created. The explosion is captured in slow motion to show the devastating effect of the flash in terms of the heat and thermal energy produced relative to the mannequin.

### Arc Rated Clothing

Protective fabrics and garments for arc flash must be rated and certified to a standard that verifies flame resistance and resistance to arc flash energy. This standard is ASTM F1506, Standard Performance Specification for Flame Resistant Textile Materials for Wearing Apparel for Use by Electrical Workers Exposed to Momentary Electric Arc and Related Thermal Hazards. Under this performance standard, fabrics and garments are tested for flame resistance and arc flash resistance. Labels are included in every garment so that employers may select the appropriate arc resistance for their employees.

### Arc Testing

Arc testing quantifies how much protection an arc rated fabric and garment provides. The arc rating is the value that describes the protective performance of the fabric in an arc exposure. NFPA 70E Standard for Electrical Safety in the Workplace addresses personal protective equipment required to safeguard employees during installation, removal and maintenance of electrical equipment. The standard categorizes personal protective equipment (PPE) for electrical work into 4 levels and assigns a minimum arc rating for each category. These specifications are listed in Table 130.7(C)(15)(c) of the NFPA 70E. The 4^{th} Arc-Flash PPE category specifies a minimum arc rating of 40 cal/cm². Because category 4 rated clothing is designed for the most dangerous levels of incident energy, the clothing has historically consisted of heavier weight garments which are known to be hot and uncomfortable for end users working in hot, humid environments.

Arc rating is expressed in cal/cm² and is reported as either Arc Thermal Performance Values (ATPV) or Energy Breakopen Threshold (EBT), whichever is the lower value. ATPV is defined in ASTM F1959/F1959M as the incident energy (cal/cm²) that results in a 50 percent probability that sufficient heat transfers through the tested specimen to cause the onset of a second degree burn injury. EBT is defined in ASTM F1959/F1959M as the incident energy (cal/cm²) on a material that results in a 50 percent probability of fabric breakopen. Breakopen is defined as a hole in the fabric with an area of at least 1.6 cm². The incidence of a significant hole assumes the onset of a second-degree burn. Consequently, fabrics that break open easily generally receive lower arc ratings. While EBT refers to the specific level of electrical energy at which a material is likely to break open or tear during an arc flash event, “Ei” is a broader term representing the incident energy, which is the total amount of heat energy transferred to a surface during an arc flash, and is used to determine the potential for burns when considering factors like the material's EBT and ATPV values. Essentially EBT is a specific point within the larger Ei measurement where the material is most likely to break apart. Unless otherwise specified, the unit of measurements for ATPV, EBT, and Ei discussed herein is cal/cm².

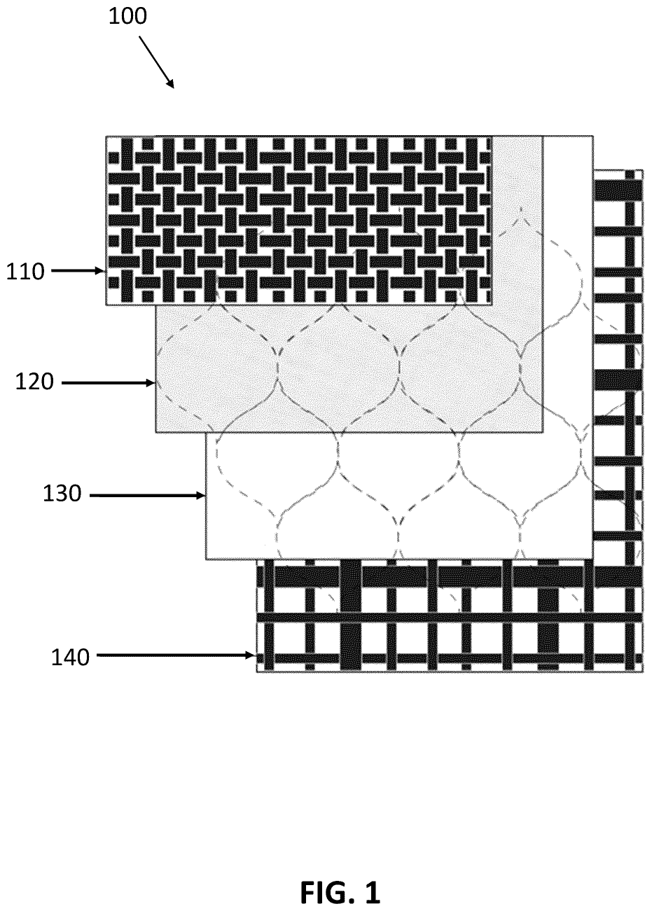

FIG. 1 shows an exemplary fabric assembly 100 for a lightweight, PFAS-free, wash-durable and highly protective fabric system. The fabric assembly 100 includes four layers 110, 120, 130, and 140 overlaying on each other. When the fabric assembly 100 is exposed to heat or arc, the layer 110 (e.g., front layer) is facing the heat or arc, the layer 140 (e.g., back layer) is a backing layer, and the layers 120 and 130 (e.g., first and second interlayers) are sandwiched between the layer 110 and the layer 140. The order of the layers 120 and 130 may be swapped. For example, in one embodiment, the assembly 100 includes the layers 110, 120, 130, and 140 in this exact order, e.g., the layer 110 on the layer 120, which is on the layer 130, which is on the layer 140. In another embodiment, the assembly 100 includes the layers 110, 130, 120, and 140 in this exact order, e.g., the layer 110 on the layer 130, which is on the layer 120, which is on the layer 140. The layers 110, 120, 130, and 140 are attached to one another or assembled via any suitable methods, including but are not limited to stitching, quilting sewing and laminating. In one example, the layers 120, 130, and 140 are quilted together and the first layer is attached to the quilted layers 120, 130, and 140 via any suitable assembly method.

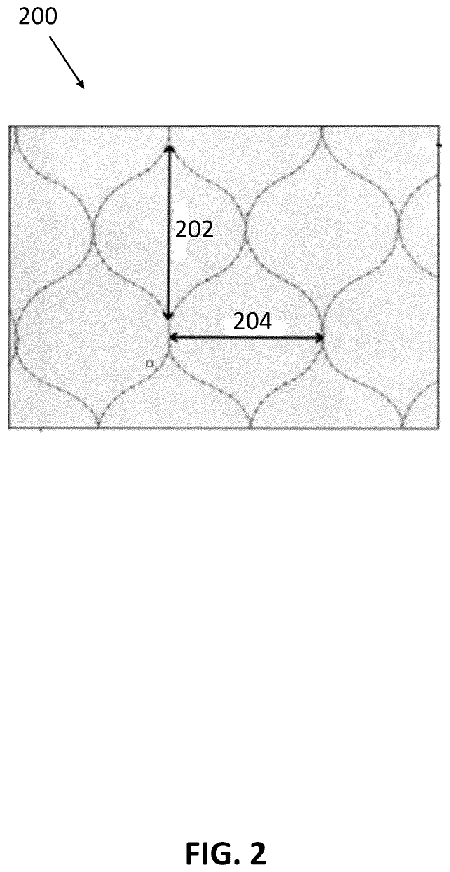

FIG. 2 shows an example patten and quilting dimensions 200 with a vertical spacing or dimension 202 and a horizontal spacing or dimension 204. The vertical spacing or dimension 202 may be between about 61 millimeters (mm) and about 73 mm, or about 67 mm. The horizontal spacing or dimension 204 may be between about 45 mm and about 56 mm, or about 51 mm. In another embodiment, the ratio of the vertical spacing 202/the horizontal spacing 204 may be between about 1.20 and about 1.62, or about 1.31.

TABLE 1

| Fabric | % Net weight of | Net weight | |
|---|---|---|---|
| Assembly 1 | a fabric assembly | 360 g/m² | Fabric Blend |
| 1^{st} Layer | 41.67% | 150 g/m² | Woven rip stop fabric made of 45 wt. % flame- |
| (layer 110) | | | resistant (FR) viscose, 43 wt. % aramid |
| | | | (aromatic polyamide), 10 wt. % polyamide, |
| | | | and 2 wt. % anti-static fiber |
| 2^{nd} Layer | 16.67% | 60 g/m² | Nonwoven spunlace fabric made of 100 wt. % |
| (layer 120) | | | para-aramid |
| 3^{rd} Layer | 13.89% | 50 g/m² | Nonwoven spunlace fabric made of 67 wt. % |
| (layer 130) | | | meta-aramid and 33 wt. % para-aramid |
| 4^{th} Layer | 27.78% | 100 g/m² | Woven plain weave fabric made of 50 wt. % |
| (layer 140) | | | FR viscose, 45 wt. % meta-aramid, and 5 wt. % |
| | | | para-aramid |

Fabric Assembly 1 shown in Table 1 is PFAS-free and includes the first layer (layer 110), the second layer (layer 120), the third layer (layer 130), and the fourth layer (layer 140) that are about 41.67%, about 16.67%, about 13.89%, and about 27.78% of the net weight of the fabric assembly, respectively. That is in a fabric assembly of about 360 g/m², the first, second, third, and fourth layers are about 150 g/m², about 60 g/m², about 50 g/m², and about 100 g/m², respectively. The first layer (layer 110) is made of a woven rip stop fabric made of about 45 weight % (wt. %) flame-resistant (FR) viscose, about 43 wt. % aramid (aromatic polyamide), about 10 wt. % polyamide, and about 2 wt. % anti-static fiber. The second layer (layer 120) is made of a nonwoven spunlace fabric made of about 100 wt. % para-aramid. The third layer (layer 130) is made of a nonwoven spunlace fabric made of about 67 wt. % meta-aramid and about 33 wt. % para-aramid. The fourth layer (layer 140) is made of a woven plain weave fabric made of about 50 wt. % FR viscose, about 45 wt. % meta-aramid, and about 5 wt. % para-aramid. The Fabric Assembly 1 exhibits an ATPV of about 39.83 without breakopen at about 49.5 Ei.

Table 2 shows another exemplary fabric construction of the fabric assembly 100.

TABLE 2

| Fabric | % Net weight of | Net weight | |
|---|---|---|---|
| Assembly 2 | a fabric assembly | 360 g/m² | Fabric Blend |
| 1^{st} Layer | 41.67% | 150 g/m² | Woven plain weave fabric made of 66 wt. % |
| (layer 110) | | | meta-aramid, 12 wt. % para-aramid, 12 wt. % |
| | | | FR viscose, 9 wt. % polyamide, and 1 wt. % |
| | | | anti-static fiber |
| 2^{nd} Layer | 16.67% | 60 g/m² | Nonwoven spunlace fabric made of 100 wt. % |
| (layer 120) | | | para-aramid |
| 3^{rd} Layer | 13.89% | 50 g/m² | Nonwoven spunlace fabric made of 67 wt. % |
| (layer 130) | | | meta-aramid and 33 wt. % para-aramid |
| 4^{th} Layer | 27.78% | 100 g/m² | Woven ripstop fabric fabric made of 50 wt. % |
| (layer 140) | | | FR viscose, 45 wt. % meta-aramid, and 5 wt. % |
| | | | para-aramid |

Fabric Assembly 2 shown in Table 2 is PFAS-free and includes the first layer (layer 110), the second layer (layer 120), the third layer (layer 130), and the fourth layer (layer 140) that are about 41.67%, about 16.67%, about 13.89%, and about 27.78% of the net weight of the fabric assembly, respectively. That is in a fabric assembly of about 360 g/m², the first, second, third, and fourth layers are about 150 g/m², about 60 g/m², about 50 g/m², and about 100 g/m², respectively. The first layer (layer 110) is made of a plain weave fabric made of about 66 wt. % meta-aramid, about 12 wt. % para-aramid, about 12 wt. % FR viscose, about 9 wt. % polyamide, and about 1 wt. % anti-static fiber. The second layer (layer 120) is made of a nonwoven spunlace fabric made of about 100 wt. % para-aramid. The third layer (layer 130) is made of a nonwoven spunlace fabric made of about 67 wt. % meta-aramid and about 33 wt. % para-aramid. The fourth layer (layer 140) is made of a woven plain weave fabric made of about 50 wt. % FR viscose, about 45 wt. % meta-aramid, and about 5 wt. % para-aramid. The Fabric Assembly 2 exhibits an ATPV of about 46.38 without breakopen at about 55.59 EBT.

Alternatively, the first layer (layer 110) may be in a weight range as light as 100 g/m², e.g., between about 100 g/m² and about 150 g/m². The fabric pattern for the first layer (layer 110) may be duck, basket, twill, satin, dobby or jacquard fabric. The fabric of the first layer (layer 110) may be produced from twisted or single yarns produced from ring spinning, open end or jet spinning. The fabric of the first layer (layer 110) may be a knit fabric. Meta-aramid may be replaced with polyamideimid.

Alternatively, the second layer (layer 120) may be in a weight range as light as 35 g/m², e.g., between about 35 g/m² and about 60 g/m². The second layer (layer 120) may include at least 75 wt. % para-aramid plus other fibers (added up to 100 wt. %) that may be nylon, meta-aramid, and/or polyamideimid. The fabric pattern for the second layer (layer 120) may be needle punch, melt blown, spunbond nonwoven, a knit or a woven fabric.

Alternatively, the third layer (layer 130) may be in a weight range as light as 35 g/m², e.g., between about 35 g/m² and about 60 g/m². The third layer (layer 130) may include as much as 85 wt. % meta-aramid, e.g., between about 67 wt. % and about 85 wt. % meta-aramid, and at least 15 wt. % para-aramid, e.g., between about 15 wt. % and about 33 wt. % para-aramid. The third layer (layer 130) may contain other fibers (added up to 100 wt. %) that may be nylon, polyamideimid, rayon, lyocell and/or cotton. The fabric pattern for the third layer (layer 130) may be needle punch, melt blown, spunbond nonwoven, a knit or a woven fabric.

Alternatively, the fourth layer (layer 140) may be in a weight range as light as 90 g/m², e.g., between about 90 g/m² and about 100 g/m². The fabric pattern may be duck, basket, twill, satin, dobby or jacquard. The fabric may be produced from twisted or single yarns produced from ring spinning, open end or jet spinning. The fabric may be a knit fabric. The fabric blend may include at least 35 wt. % FR viscose and a range of other fibers. For example, the fabric blend may include about 85 wt. % FR viscose and about 15 wt. % para-aramid. For example, the fabric blend may include about 35 wt. % FR viscose, about 15 wt. % para-aramid and about 50 wt. % meta-aramid. The fabric blend may include up to 15 wt. % nylon, e.g., between about 0.1 wt. % and about 15 wt. % nylon. Polyamideimid may be replaced by meta-aramid in the blend.

The alternative embodiments discussed above (e.g., alternatives in weight range, fabric pattern, fabric blend, etc.) may be combined in various combinations to provide the NFPA 70E 3^{rd} or 4^{th} Arc-Flash category protection. For example, one or more of the layers 110, 120, 130, and 140 may be made with a higher weight range than what is shown in Tables 1 and 2, such that a breakopen energy of about 75 cal/cm² (under NFPA 70E 4^{th} Arc-Flash category) can be achieved at a relatively higher assembly net weight, e.g., between about 365 g/m² and about 460 g/m². For example, one or more of the layers 110, 120, 130, and 140 may be made with a lower weight range that what is shown in Tables 1 and 2, such that a breakopen energy of about 25 cal/cm² (under NFPA 70E 3^{rd} Arc-Flash category) can be achieved at a relatively higher assembly net weight, e.g., between about 260 g/m² and about 355 g/m². For example, the fabric assembly disclosed herein is perfluoroalkyl and polyfluoroalkyl substances (PFAS)-free and has an arc thermal performance value (ATPV) of greater than 39 cal/cm² when a net weight of the fabric assembly is between about 260 g/m² and about 370 g/m². For example, the fabric assembly disclosed herein is perfluoroalkyl and polyfluoroalkyl substances (PFAS)-free and has an arc thermal performance value (ATPV) of between about 25 cal/cm² and about 75 cal/cm² when a net weight of the fabric assembly is between about 260 g/m² and about 460 g/m².

Table 3 shows a comparison between performances of various fabric assemblies. Sample No. 1 corresponds to Assembly 1 in Table 1, Sample No. 2 corresponds to Assembly 2 in Table 2, and Samples 3-8 are different from Samples 1 and 2 in fabric construction and/or fabric blend. Fabric performance is rated in terms of ATPV, EBT, and/or Ei. The “1^{st}” layer is facing the heat or arc, the last layer, e.g., “2^{nd}”, “3^{rd}” or “4^{th}” layer is a backing layer.

TABLE 3

| | Fabric | Fabric | Fabric Weight | Fabric Blend | Performance |
|---|---|---|---|---|---|
| No. | Type | Construction | (Oz/Sq Yd) | (wt. %) | Results |
| 1 | Woven | 1ₛₜ layer | 4.4 | 45 FR Viscose/43 | ATPV 39.83 |
| | | | | Aramid/10 Polyamide/2 | No breakopen at |
| | | | | Anti-static fiber | 49.5 Ei |
| | Non- | 2_{nd} layer | 1.77 | 100 Para-aramid | |
| | woven | | | | |
| | Non- | 3_{rd} layer | 1.47 | 67 Meta-aramid/33 Para- | |
| | woven | | | aramid | |
| | Woven | 4ₜₕ layer | 2.95 | 50 FR Viscose/45 Meta- | |
| | | | | aramid/5 Para-aramid | |
| | Assembly | | 10.59 | | |
| 2 | Woven | 1ₛₜ layer | 4.4 | 66 Meta-aramid/12 FR | ATPV = 46.38 |
| | | | | Viscose/9 Nylon/12 | EBT 55.59 |
| | | | | Para-aramid/1 Anti-static | |
| | | | | fiber | |
| | Non- | 2_{nd} layer | 1.77 | 100 Para-aramid | |
| | woven | | | | |
| | Non- | 3_{rd} layer | 1.47 | 67 Meta-aramid/33 Para- | |
| | woven | | | aramid | |
| | Woven | 4ₜₕ layer | 2.95 | 50 FR Viscose/45 Meta- | |
| | | | | aramid/5 Para-aramid | |
| | Assembly | | 10.59 | | |
| 3 | Woven | 1ₛₜ layer | 4.4 | 66 Meta-aramid/12 FR | Breakopen at |
| | | | | Viscose/9 Nylon/12 | 32.84 Ei |
| | | | | Para-aramid/1 Anti-static | |
| | | | | fiber | |
| | Non- | 2_{nd} layer | 2.36 | 67 Meta-aramid/33 Para- | |
| | woven | | | aramid | |
| | Woven | 3_{rd} layer | 2.65 | 99 Polyamide Imide/1 | |
| | | | | Anti-static | |
| | Assembly | | 9.41 | | |
| 4 | Woven | 1ₛₜ layer | 4.4 | 66 Meta-aramid/12 FR | Estimated |
| | | | | Viscose/9 Nylon/12 | ATPV 38 |
| | | | | Para-aramid/1 Anti-static | Estimated |
| | | | | fiber | EBT 42 |
| | Non- | 2_{nd} layer | 3.54 | 67 Meta-aramid/33 Para- | |
| | woven | | | aramid | |
| | Woven | 3_{rd} layer | 2.65 | 99 Polyamide Imide/1 | |
| | | | | Anti-static | |
| | Assembly | | 10.59 | | |
| 5 | Woven | 1ₛₜ layer | 4.4 | 66 Meta-aramid/12 FR | Burn at 39.1 |
| | | | | Viscose/9 Nylon/12 | Burn and |
| | | | | Para-aramid/1 Anti-static | breakopen at |
| | | | | fiber | 40.1 Ei |
| | Non- | 2_{nd} layer | 2.36 | 100 Kynol | |
| | woven | | | | |
| | Non- | 3_{rd} layer | 1.47 | 67 Meta-aramid/33 Para- | |
| | woven | | | aramid | |
| | Woven | 4ₜₕ layer | 2.65 | 99 Polyamide Imide/1 | |
| | | | | Anti-static | |
| | Assembly | | 10.88 | | |
| 6 | Woven | 1ₛₜ layer | 4.4 | 66 Meta aramid/12 | Burn and |
| | | | | Viscose FR/9 Nylon/12 | breakopen at |
| | | | | Para aramid/1 Anti-static | 36.6 Ei |
| | | | | fiber | |
| | Non- | 2_{nd} layer | 3.69 | 85 Viscose FR/15 Para | |
| | woven | | | aramid | |
| | Woven | 3_{rd} layer | 2.65 | 99 Polyamide-imide/1 | |
| | | | | Anti-static | |
| | Assembly | | 10.74 | | |
| 7 | Woven | 1ₛₜ layer | 4.4 | 66 Meta-aramid/12 FR | Burn and |
| | | | | Viscose/9 Nylon/12 | breakopen at |
| | | | | Para-aramid/1 Anti-static | 35.7 Ei |
| | | | | fiber | |
| | Structured | 2_{nd} layer | 3.69 | 85 FR Viscose/15 Para- | |
| | Non- | | | aramid | |
| | woven | | | | |
| | Woven | 3_{rd} layer | 2.65 | 99 Polyamide-imide/1 | |
| | | | | Anti-static | |
| | Assembly | | 10.74 | | |
| 8 | Woven | 1ₛₜ layer | 6.5 | 93 Meta-aramid/5 Para- | Burn and |
| | | | | aramid/2 Anti-static fiber | breakopen at |
| | Woven | 2_{nd} layer | 4.4 | 66 Meta-aramid/12 FR | 39.9 Ei |
| | | | | Viscose/9 Nylon/12 | |
| | | | | Para-aramid/1 Anti-static | |
| | | | | fiber | |
| | Assembly | | 10.9 | | |

The fabric construction of Fabric Assembly 2 only differs from that of Fabric Assembly 1 in the choice of fabric of the first layer. Both Fabric Assemblies 1 and 2 are PFAS-free and still exhibit surprisingly outstanding ATPV and EBT or Ei values in comparison to Samples 3-8. The improvements may be contributed by two factors. First, the fabric construction of the second layer (layer 120) made of para-aramid followed by the third layer (layer 130) made of meta-aramid and para-aramid quilted to the woven fourth layer (layer 140), provides a significant resistance to breakopen. Furthermore, when such fabric construction is combined with the first layer (layer 110) made of a woven plain weave fabric made of about 66 wt. % meta-aramid, about 12 wt. % para-aramid, about 12 wt. % FR viscose, about 9 wt. % polyamide, and about 1 wt. % anti-static fabric, the overall protection of Fabric Assembly 2 is dramatically increased to provide an ATPV of 46.38.

As used herein, “FR Viscose” is a man-made cellulosic fiber which is flame retardant by incorporating “phosphorous” in the viscose matrix. The phosphorous flame retardant is incorporated at the fiber spinning stage. An example of FR Viscose includes, but is not limited to, FR Viscose-T100 available from Aramid HPM, LLC High Performance Materials.

As used herein, the term “nylon fiber” refers to a fiber consisting essentially of a polyamide synthetic polymer. Polyamide is a thermoplastic having high abrasion resistance and toughness. Addition of nylon fiber to the fiber blend may increase abrasion resistance of a fabric.

As used herein, “Kynol” is a high-performance novoloid fiber with a three-dimensional network structure which originates from the reactivity of phenol. An example of Kynol includes, but is not limited to, Kynol® available from KYNOL EUROPA GmbH, Germany.

As used herein, the term “aramid fiber” refers to a manufactured fiber in which the fiber-forming substance is a long-chain synthetic polyamide in which at least 85% of the amide linkages, (—CO—NH—), are attached directly to two aromatic rings, including, but not limited to, para-aramid (p-aramid) and meta-aramid (m-aramid). Aramid fiber is a strong, heat-resistant fiber formed of polymers with repeating aromatic groups branching from a carbon backbone, used in materials for bulletproof vests and radial tires. Examples of para-aramids include, but are not limited to, poly(p-phenylene terephthalamide) (available from KEVLAR® DuPont de Nemours and Company), TWARON® (available from Teijin Twaron BV headquartered in Arnhem, the Netherlands), and TECHNORA (an aramid that is useful for a variety of applications that required high strength or chemical resistance; available from the company Teijin Aramid). KEVLAR is a para-aramid fiber having a very high tenacity of between 28 and 32 grams/denier and outstanding heat resistance.

Examples of meta-aramids include, but are not limited to, poly(m-phenylene isophthalamide), such as NOMEX® (available from E.I. du Pont de Nemours and Company) and CONEX® (available from Teijin Twaron BV). Unlike Kevlar, Nomex cannot align during filament formation and is typically not as strong as para-aramid or KEVLAR. Meta-aramid, however, has excellent thermal, chemical, and radiation resistance. Aramid fibers feature excellent thermal stability and are highly non-flammable. These fibers have a very high resistance to heat and are resistant to melting, dripping and burning at a temperature of at least 700° F. Meta-aramids and para-aramids are inherently hydrophobic but in some cases may be treated to render them hydrophilic, at least temporarily.

Most aramid fibers are not dye accepting and, when incorporated into a fiber blend in a high concentration, can significantly limit the color ranges possible for a fabric. However, some aramid fibers are printable, or dye accepting. For example, a low-crystallized type meta-aramid fiber, such as NOMEX® 462 (available from E.I. du Pont de Nemours and Company), is a printable meta-aramid. In addition, some meta-aramid fibers are available as producer-colored meta-aramids, wherein fibers are colored during manufacturing of the fibers.

As used herein, the term “anti-static fiber” or conductive refers to a fiber that, when incorporated into a fabric or other material, eliminates or reduces static electricity. Suitable fibers include, but are not limited to, metal fibers (steel, copper or other metal), metal-plated polymeric fibers, and polymeric fibers incorporating carbon black on the surface and/or in the interior of the fiber, such as those described in U.S. Pat. Nos. 3,803,453, 4,035,441, 4,107,129, and the like. Anti-static carbon fiber is a preferred anti-static fiber. One example of a conductive fiber is NEGASTAT® (available from E.I. du Pont de Nemours and Company), a carbon fiber comprising a carbon core of conductive carbon surrounded by a non-conductive polymer cover, either nylon or polyester. INVISTA No-Shock® anti-static fiber is another example. By way of example, a steel wire is available under the names BEKINOX and BEKITEX from Bekaert S.A. in a diameter as small as 0.035 millimeter. Another anti-static fiber is the product X-static made by Noble Fiber Technologies, a nylon fiber coated with a metal (silver) layer. The X-static fibers may be blended with other fibers, such as meta-aramid, in the process of yarn spinning.

As used herein, the term “fabric weight”, “net weight,” or “basis weight” refer to a measure of the weight of a fabric per unit area. Typical units include ounces per square yard and grams per square centimeter.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the disclosure be defined by the following claims and their equivalence.

In one aspect, a method may include an operation, an instruction, and/or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

The functions, acts or tasks illustrated in the Figures or described may be executed in a digital and/or analog domain and in response to one or more sets of logic or instructions stored in or on non-transitory computer readable medium or media or memory. The functions, acts or tasks are independent of the particular type of instructions set, storage media, processor or processing strategy and may be performed by software, hardware, integrated circuits, firmware, microcode and the like, operating alone or in combination. The memory may comprise a single device or multiple devices that may be disposed on one or more dedicated memory devices or disposed on a processor or other similar device. When functions, steps, etc. are said to be “responsive to” or occur “in response to” another function or step, etc., the functions or steps necessarily occur as a result of another function or step, etc. It is not sufficient that a function or act merely follow or occur subsequent to another. The term “substantially” or “about” encompasses a range that is largely (anywhere a range within or a discrete number within a range of ninety-five percent and one-hundred and five percent), but not necessarily wholly, that which is specified. It encompasses all but an insignificant amount.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112(f) unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

1. A fabric assembly, comprising:
a front layer made of a first woven fabric;
a back layer made of a second woven fabric;
a first interlayer made of a first non-woven fabric; and
a second interlayer made of a second non-woven fabric,
wherein the first and second interlayers are disposed between the front layer and the back layer, the first interlayer directly contacts the front layer and the second interlayer directly contacts the back layer, and
wherein the fabric assembly is perfluoroalkyl and polyfluoroalkyl substances (PFAS)-free and has an arc thermal performance value (ATPV) of greater than 39 calories/centimeter square (cal/cm²) when a net weight of the fabric assembly is between about 260 gram/square meter (g/m²) and about 370 g/m².

2. The fabric assembly of claim 1, wherein the fabric assembly has an energy breakopen threshold (EBT) of 55.59 cal/cm² with the ATPV=46.38 cal/cm².

3. The fabric assembly of claim 1, wherein the fabric assembly has an ATPV greater than or equal to 39.83 cal/cm².

4. The fabric assembly of claim 1, wherein the first woven fabric is made of about 66 weight % (wt. %) meta-aramid, about 12 wt. % para-aramid, about 12 wt. % FR viscose, about 9 wt. % polyamide, and about 1 wt. % anti-static fiber.

5. The fabric assembly of claim 1, wherein the first woven fabric is made of about 45 wt. % flame-resistant (FR) viscose, about 43 wt. % aramid, about 10 wt. % polyamide, and about 2 wt. % anti-static fiber.

6. The fabric assembly of claim 1, wherein the second woven layer is made of about 50 wt. % FR viscose, about 45 wt. % meta-aramid, and about 5 wt. % para-aramid.

7. The fabric assembly of claim 1, wherein the first non-woven fabric is made of about 100 wt. % para-aramid.

8. The fabric assembly of claim 1, wherein the second non-woven fabric is made of about 67 wt. % meta-aramid and about 33 wt. % para-aramid.

9. The fabric assembly of claim 1, wherein the first and second non-woven fabrics are non-woven spunlace fabrics.

10. The fabric assembly of claim 1, wherein the front layer is about 41.67%, the first interlayer is about 16.67%, the second interlayer is about 13.89%, and the back layer is about 27.78% net weight of the fabric assembly.

11. An article, comprising:
a fabric assembly comprising:
a front layer made of a first woven fabric;
a back layer made of a second woven fabric;
a first interlayer made of a first non-woven fabric; and
a second interlayer made of a second non-woven fabric,
wherein the first and second interlayers are disposed between the front layer and the back layer, the first interlayer directly contacts the front layer and the second interlayer directly contacts the back layer, and
wherein the fabric assembly is perfluoroalkyl and polyfluoroalkyl substances (PFAS)-free and has an arc thermal performance value (ATPV) of greater than 39 calories/centimeter square (cal/cm²) when a net weight of the fabric assembly between about 260 gram/square meter (g/m²) and about 370 g/m².

12. The article of claim 11, wherein the fabric assembly has an energy breakopen threshold (EBT) of 55.59 cal/cm² with the ATPV=46.38 cal/cm².

13. The article of claim 11, wherein the fabric assembly has an ATPV greater than or equal to 39.83 cal/cm².

14. The article of claim 11, wherein the first woven fabric is made of about 66 weight % (wt. %) meta-aramid, about 12 wt. % para-aramid, about 12 wt. % FR viscose, about 9 wt. % polyamid, and about 1 wt. % anti-static fiber.

15. The article of claim 11, wherein the first woven fabric is made of about 45 wt. % flame-resistant (FR) viscose, about 43 wt. % aramid, about 10 wt. % polyamide, and about 2 wt. % anti-static fiber.

16. The article of claim 11, wherein the second woven layer is made of about 50 wt. % FR viscose, about 45 wt. % meta-aramid, and about 5 wt. % para-aramid.

17. The article of claim 11, wherein the first non-woven fabric is made of about 100 wt. % para-aramid.

18. The article of claim 11, wherein the second non-woven fabric is made of about 67 wt. % meta-aramid and about 33 wt. % para-aramid.

19. The article of claim 11, wherein the first and second non-woven fabrics are non-woven spunlace fabrics.

20. The article of claim 11, wherein the front layer is about 41.67%, the first interlayer is about 16.67%, the second interlayer is about 13.89%, and the back layer is about 27.78% net weight of the fabric assembly.
